(19) United States
(12) Patent Application Publication
(10) Pub. No.: US 2004/0093429 A1
(43) Pub. Date: May 13, 2004

(54) System for targeted messaging and method of operation thereof

(76) Inventors: James John Henry Burton, Province (ZA); Dale John Williams, Cape Province (ZA)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 10/469,362

(22) PCT Filed: Feb. 21, 2002
(86) PCT No.: PCT/IB02/00518

(30) Foreign Application Priority Data
Feb. 27, 2001 (ZA) 2001/1602

(51) Int. Cl. G06F 15/173

(52) U.S. Cl. 709/242

(57) ABSTRACT

A system for targeted messaging comprises a sending workstation operable by a sender to transmit a message to an intended recipient along a communication network, a receiving workstation operable by a recipient to receive the message from the sender along the communication network, an insertion facility responsive to transmission of the message to insert a desired one of a number of different codes into the transmitted message, a decision repository with a number of stored selection rules for selecting the desired one of the number of different codes into the transmitted message; and a display for displaying the inserted code at the receiving workstation.

### FIELD OF THE INVENTION

This invention relates to a system for targeted messaging and, more particularly, to a system for implementing targeted electronic messaging on an open communication network such as the internet. The invention extends to a method for implementing targeted messaging.

### BACKGROUND TO THE INVENTION

The advent of open communication networks such as the Internet has led to an increasing popularity and use of electronic messaging such as e-mail. E-mail is today widely used by businesses and individuals as a preferred medium for person-to-person written communication.

A disadvantage with conventional e-mail is that it is primarily character-based. Although it is possible to include graphic images in an e-mail message, current methodologies for doing so are cumbersome and time-consuming. Thus, although the business enterprise may customize its stationery such as correspondence paper, envelopes, compliment slips and business cards, its e-mails are generally sent as text-only messages, thereby wasting an opportunity to promote awareness of a corporate brand.

Similarly, it has hitherto been difficult to utilize an e-mail message to conduct marketing that is specifically targeted to a recipient of the message. One attempt at overcoming this difficulty is by means of the introduction of one or more clickable icons (or “banners”) into an e-mail message. A recipient of the message is able to click on the banner contained in the message, and will then be redirected to an Internet website associated with that banner. This methodology does not, however, enable such marketing to be targeted specifically at the recipient of the message.

Another method of disseminating Internet advertising banners by means of e-mail is through so-called “opt-in groups”. In such an arrangement, persons voluntarily join the closed group of individuals who receive e-mail messages that are exclusively advert-based, usually in exchange for some financial reward. An example of such an opt-in group is the “E-merge” group available at URL 247media.com.

### OBJECT OF THE INVENTION

It is an object of this invention to provide a system for targeted messaging, and a method for implementing targeted messaging that will, at least partially, alleviate the above-mentioned difficulties and disadvantages.

### SUMMARY OF THE INVENTION

In accordance with the invention there is provided a system for targeted messaging, comprising:

a sending workstation operable by the sender to transmit a message to an intended recipient along a communication network;

a receiving workstation operable by a recipient to receive the message from the sender along the communication network;

insertion means responsive to transmission of the message to insert a desired one of a number of different codes into the transmitted message;

a decision repository having at least one stored selection rule for selecting the desired one of the number of different codes into the transmitted message; and

a display facility operable to display the inserted code at the receiving workstation.

Further features of the invention provide for the insertion means to be responsive to transmission of the message to insert a plurality of different desired codes into the transmitted message, for the insertion means to be an application program executable on an application server communicable with the sending workstation, for the decision repository to include a register of authorized recipients of the message, for the decision repository to also include a register of authorized senders of the message, for the decision repository to include, further, a register of a number of different codes insertable into a transmitted message, for the decision repository to include, still further a selection rule database having a number of different selection rules stored therein for selecting the desired code to be inserted into the transmitted message, for each sender in the register of authorized senders to be linked to a corresponding preferred one of the codes in the register of insertable codes, for each recipient in the register of authorized recipients to also be linked to a corresponding preferred one of the codes in the register of insertable codes, and for one of the codes in the register of insertable codes to be a default insertable code.

Still further features of the invention provide for a first one of the stored selection rules in the database of selection rules to select the linked preferred code corresponding to a recipient of the message as the desired code for insertion into the message when the recipient is an authorized recipient, for a second one of the stored selection rules in the database of selection rules to select the linked preferred code corresponding to a sender of the message as the desired code for insertion into the message when the recipient of the message is not an authorized recipient and the sender is an authorized sender, and for a third one of the selection rules in the database of stored selection rules to select the default insertable code as the desired code for insertion into the message when the recipient of the message is not an authorized recipient and the sender is not an authorized sender.

Yet further features of the invention provide for the system to include a configuration facility operable by a user of the system, for the configuration facility to be operable to add and delete a recipient from the register of authorized recipients, for the configuration facility to be operable to add and delete a sender from the register of authorized senders, for the configuration facility to be operable to add and delete a code from the register of insertable codes, for the configuration facility to be operable to link and de-link any one of the codes in the register of insertable codes to any one or more of the authorized recipients and authorized senders as the corresponding preferred insertable code, and for the configuration facility to be operable to select and de-select the default insertable code.

There is also provided for the desired insertable code to be activatable by the recipient to access a repository of information, for the system to include a detection facility operable to detect activation of the insertable code for access to the repository of information, for the message transmitted by the sender to the intended recipient to be an e-mail message, for the communication network to be an open communication network, for the open communication network to be the Internet, and for the repository of information to be a website on the World Wide Web of the Internet.

The invention extends to a method for implementing targeted messaging, comprising the steps of:

inserting a desired one of a number of different codes into a message to be transmitted by a sender to an intended recipient; the desired one of the number of different codes being selected according to at least one selection rule stored in a decision repository;

transmitting the message to an intended recipient along a communication network;

receiving the message from the sender along the communication network; and displaying the inserted code at the receiving workstation.

There is further provided for inserting a plurality of different desired codes into the transmitted message prior to transmission thereof to the intended recipient along the communication network, for inserting the desired one of a plurality if different codes into the message by means of an application program executable on an application server, for including in the decision repository a register of authorized recipients of the message, for also including in the decision repository a register of authorized senders of the message, for including, further, in the decision repository a register of a number of different codes insertable into the transmitted message, for including, still further, in the decision repository a selection rule database having a number of different selection rules stored therein for selecting the desired code to be inserted into the transmitted message, for linking each sender in the register of authorized senders to a corresponding preferred one of the codes in the register of insertable codes, for also linking each recipient in the register of authorized recipients to a corresponding preferred one of the codes in the register of insertable codes, and for specifying one of the codes in the register of insertable codes to be a default insertable code.

There is still further provided for selecting the linked preferred code corresponding to a recipient of the message as the desired code for insertion into the message when the recipient is an authorized recipient, for selecting the linked preferred code corresponding to a sender of the message as the desired code for insertion into the message when the recipient of the message is not an authorized recipient and the sender is an authorized sender, and for selecting the default insertable code as the desired code for insertion into the message when the recipient of the message is not an authorized recipient and the sender is not an authorized sender.

There is yet further provided for the method to include the further step of configuring the decision repository, for configuring the decision repository by adding and deleting a recipient from the register of authorized recipients, for configuring the decision repository by adding and deleting a sender from the register of authorized senders, for configuring the decision repository by adding and deleting a code from the register of insertable codes, for configuring the decision repository by linking and de-linking any one of the codes in the register of insertable codes to any one or more of the authorized recipients and authorized senders as the corresponding preferred insertable code, and for configuring the decision repository by selecting and de-selecting the default insertable code.

There is also provided for the method to include the further step of activating desired inserted code by the recipient to access a repository of information, and for detecting activation of the insertable code to access the repository of information.

### BRIEF DESCRIPTION OF THE DRAWINGS

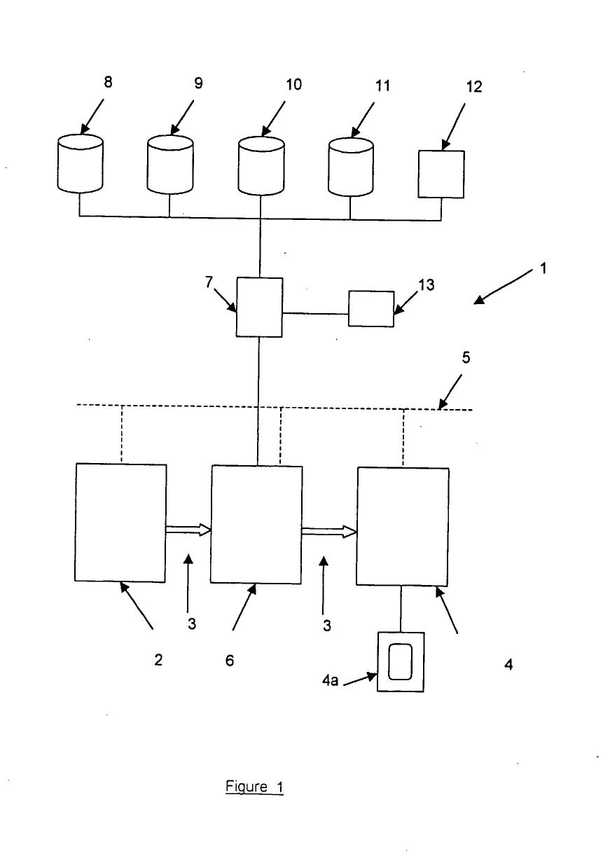

Preferred embodiments of the invention are described below, by way of example only, and with reference to FIG. 1 which shows a block diagrammatic layout of a system for targeting messaging.

### DETAILED DESCRIPTION OF THE INVENTION

Referring to FIG. 1, a system for targeted messaging is indicated generally by reference numeral 1.

The system 1 includes a sending workstation 2 operable by a sender to transmit any e-mail message 3 conforming to the well-known mail transport protocol such as the Simple Mail Transfer Protocol (SMTP) and the Messaging Application Program Interface (MAPI), to an intended recipient at a receiving workstation 4. The receiving workstation 4 includes a display facility 4a operable to display the contents of the received e-mail message. The sending workstation 2 and the receiving workstation 4 are connected to an open communication network in the form of the Internet 5.

For convenience, the communication network 5 is shown in dotted lines in FIG. 1, while arrows represent different messages transmitted across the communication network.

The system 1 also includes insertion means in the form of an application program which is executable on an Internet application server 6, the operation of which will be described in detail in the description that follows. A decision repository 7 is stored on a storage medium (not shown) associated with the application server 6. The decision repository 7 includes a register 8 of known (or authorized) recipients of the e-mail message, as well as a register 9 of known (or authorized) senders of the e-mail message. The decision repository 7 includes, further, a register 10 of a number of different codes insertable into a transmitted e-mail message. The decision repository 7 includes, still further, a selection rule database 11 having a number of different selection rules stored therein for selecting one or more desired codes to be inserted into the transmitted e-mail message. The decision repository is configurable by means of a configuration facility 12 to cause each sender in the register 9 of authorized senders to be linked to a corresponding preferred one of the codes in the register 10 of insertable codes. Further, the decision repository is also configurable to cause each recipient in the register 8 of authorized recipients to also be linked to a corresponding preferred one of the codes in the register 10 of insertable codes. Lastly, one of the codes in the register of insertable codes 10 is configurable to be a default insertable code.

A first one of the stored selection rules in the database 11 of selection rules selects the linked preferred code corresponding to a recipient of the e-mail message as the desired code for insertion into the message when the recipient is an authorized recipient that appears in the register 8 of authorized recipients. A second one of the stored selection rules in the database 11 of selection rules selects the linked preferred code corresponding to a sender of the e-mail message as the desired code for insertion into the message when the recipient of the message is not an authorized recipient and the sender is an authorized sender that appears in the register 9 of authorized senders. Lastly, a third one of the selection rules in the database 11 of stored selection rules selects the default insertable code as the desired code for insertion into the e-mail message when the recipient of the message is not an authorized recipient and the sender is not an authorized sender.

In use, when an e-mail message is transmitted by the sending workstation 2 to the intended recipient, the message is re-directed to the application server 6. The application program on the application server 6 scans the e-mail message and derives therefrom an identity of the sender of the message as well as an identity of the intended recipient. The application program then inserts into the transmitted e-mail message a desired one of the number of different codes in the register 10 of insertable codes according to the following steps:

if the identity of the recipient of the e-mail message matches an entry in the register 8 of authorized recipients, the linked preferred code corresponding to that particular recipient is inserted into the e-mail message as the desired code;

if the identity of the recipient of the e-mail message matches an entry in the register 8 of authorized recipients and no corresponding linked preferred code has been configured for that recipient, the default insertable code is inserted into the e-mail message as the desired code;

if the identity of the recipient of the e-mail message does not match any entry in the register 8 authorized recipients, the identity of the sender of the e-mail is compared against the entries in the register 9 of authorized senders;

if the identity of the sender of the e-mail message matches an entry in the register 9 of authorized senders, the linked preferred code corresponding to that particular sender is inserted into the e-mail message as the desired code;

if the identity of the sender of the e-mail message matches an entry in the register 9 of authorized senders and no corresponding linked preferred code has been configured for that sender, the default insertable code is inserted into the e-mail message as the desired code;

if the identity of the sender of the e-mail message does not match any entry in the register 9 of authorized senders, the default insertable code is inserted into the e-mail message as the desired code; and

Once the desired code has been inserted as described above, the e-mail message is forwarded by the application server 6 along the communication network 5 to the intended recipient via the sender's Internet mail server (not shown) in a manner which is well known in the art, and which will not be described here in detail.

When the intended recipient collects the e-mail message from the Internet mail server (not shown) and opens the message, the message contents together with the inserted code are displayed on the receiving workstation 4. The inserted code can relate to any particular content and it is envisaged that it will generally contain some promotional material, such as a branding or marketing message of a type that is used by a commercial enterprise on most paper-based communications, like letterhead paper, compliment slips, invoices, envelopes and the like. The inserted code can contain any digital graphic image, text or any other digital format. Preferably HyperTex Markup Language (HTML) code will be used to import the graphic content at the time of sending the message.

The inserted code is displayed to the intended recipient as a clickable icon or banner that includes a URL address. The application server 6 also includes a detection facility 13 in the form of a software application that detects and records a click-through on the icon by the intended recipient. The URL address is generally that of an Internet website and is used to direct the intended recipient to a repository of information on the World Wide Web of the Internet.

The configuration facility 12 in the form of an application program in the application server 6 is operable by a user of the system 1 to add and delete a particular recipient from the register of authorized recipients 5 in the decision repository 7. Similarly, the configuration facility 12 is operable by the user to add and delete any sender from the register 9 of authorized senders, and to add and delete a code from the register 10 of insertable codes. Further, the configuration facility 12 is operable to link and de-link any one of the codes in the register 10 of insertable codes to any one or more of the authorized recipients and authorized senders as the corresponding preferred insertable code, and to select and de-select the default insertable code.

It will be appreciated that the software necessary to operate the various systems fall within the knowledge of those skilled in the art and need not be described for the purposes of this patent specification.

Numerous modifications are possible to this embodiment without departing from the scope of this invention. In particular the database 11 of selections may contain different selection rules to cause, for example, more than one desired code to be inserted into the e-mail message. Further, the communication network 5 may be a closed communication network, or an open communication network other than the Internet. Further, different selection rules may be used to determine selection of the desired insertable code to be inserted into the e-mail message. Still further, the functionality of the application server 6 may be integrated with that of an internal communication network of a business enterprise, thereby allowing all of the users to the enterprise's communication network to be configured as authorized senders in the register 9 of authorized senders. Yet further, the application server 6 may be integrated with existing firewall protection of the communication network of the business enterprise in order to minimize the risks of a breach of the security of the enterprise's communication network.

It will also be understood that the concept “workstation” as used in this specification will include palm pilots and similar services.

The invention therefore provides a system for providing targeted electronic messaging on an open communication network such as the Internet.

1. A system for targeted messaging, comprising:
a sending workstation operable by the sender to transmit and message to an intended recipient along a communication network;
a receiving workstation operable by a recipient to receive the message from the sender along the communication network;
insertion means responsive to transmission of the message to insert a desired one of a number of different codes into the transmitted message;
a decision repository having at least one stored selection rule for selecting the desired one of the number of different codes into the transmitted message; and
a display facility operable to display the inserted code at the receiving workstation.

2. A system for targeted messaging as claimed in claim 1, in which the insertion means is responsive to transmission of the message to insert a plurality of different desired codes into the transmitted message.

3. A system for targeted messaging as claimed in either one of the preceding claims in which the insertion means is an application program executable on an application server communicable with the sending workstation.

4. A system for targeted messaging as claimed in any one of the preceding claims in which the decision repository includes a register of authorized recipients of the message.

5. A system for targeted messaging as claimed in claim 4 in which the decision repository also includes a register of authorized senders of the message.

6. A system for targeted messaging as claimed in claim 5 in which the decision repository includes, further, a register of a number of different codes insertable into a transmitted message.

7. A system for targeted messaging as claimed in claim 6 in which the decision repository includes, still further, a selection rule database having a number of different selection rules stored therein for selecting the desired code to be inserted into the transmitted message.

8. A system for targeted messaging as claimed in claim 7 in which each sender in the register of authorized senders is linked to a corresponding preferred one of the codes in the register of insertable codes.

9. A system for targeted messaging as claimed in claim 8 in which each recipient in the register of authorized recipients is also linked to a corresponding preferred one of the codes in the register of insertable codes.

10. A system for targeted messaging as claimed in claim 9 in which one of the codes in the register of insertable codes is a default insertable code.

11. A system for targeted messaging as claimed in claim 10 in which a first one of the stored selection rules in the database of selection rules selects the linked preferred code corresponding to a recipient of the message as the desired code for insertion into the message when the recipient is an authorized recipient.

12. A system for targeted messaging as claimed in claim 11 in which a second one of the stored selection rules in the database of selection rules selects the linked preferred code corresponding to a sender of the message as the desired code for insertion into the message when the recipient of the message is not an authorized recipient and the sender is an authorized sender.

13. A system for targeted messaging as claimed in claim 12 in which a third one of the selection rules in the database of stored selection rules selects the default insertable code as the desired code for insertion into the message when the recipient of the message is not an authorized recipient and the sender is not an authorized sender.

14. A system for targeted messaging as claimed in claim 13 which includes a configuration facility operable by a user of the system.

15. A system for targeted messaging as claimed in claim 14 in which the configuration facility is operable to add and delete a recipient from the register of authorized recipients.

16. A system for targeted messaging as claimed in claim 15 in which the configuration facility is operable to add and delete a sender from the register of authorized senders.

17. A system for targeted messaging as claimed in claim 16 in which the configuration facility is operable to add and delete a code from the register of insertable codes.

18. A system for targeted messaging as claimed in claim 17 in which the configuration facility is operable to link and de-link any one of the codes in the register of insertable codes to any one or more of the authorized recipients and authorized senders as the corresponding preferred insertable code.

19. A system for targeted messaging as claimed in claim 18 in which the configuration facility is operable to select and de-select the default insertable code.

20. A system for targeted messaging as claimed in claim 19 in which the desired insertable code is activatable by the recipient to access a repository of information.

21. A system for targeted messaging as claimed in claim 20 which includes a detection facility operable to detect activation of the insertable code for access to the repository of information.

22. A system for targeted messaging as claimed in any one of the preceding claims in which the message transmitted by the sender to the intended recipient is an e-mail message.

23. A system for targeted messaging as claimed in any one of the preceding claims in which the communication network is an open communication network.

24. A system for targeted messaging as claimed in claim 23 in which the open communication network is the Internet.

25. A system for targeted messaging as claimed in claim 24 in which the repository of information is a website on the World Wide Web of the Internet.

26. A method for implementing targeted messaging, comprising the steps of:
inserting a desired one of a number of different codes into a message to be transmitted by a sender to an intended recipient, the desired one of the number of different codes being selected according to at least one selection rule stored in a decision repository;
transmitting the message to an intended recipient along a communication network;
receiving the message from the sender along the communication network; and displaying the inserted code at the receiving workstation.

27. A method for implementing targeted messaging as claimed in claim 26 which includes the step of inserting a plurality of different desired codes into the transmitted message prior to transmission thereof to the intended recipient along the communication network.

28. A method for implementing targeted messaging as claimed in either one of claims 26 or 27 in which the desired one of a plurality of different codes is inserted into the message by means of an application program executable on an application server.

29. A method for implementing targeted messaging as claimed in any one claims 26 to 28 in which a register of authorized recipients of the message is included in the decision repository.

30. A method for implementing targeted messaging as claimed in claim 29 in which a register of authorized senders of the message is also included in the decision repository.

31. A method for implementing targeted messaging as claimed in claim 30 in which a register of a number of different codes insertable into the transmitted message is further included in the decision repository.

32. A method for implementing targeted messaging as claimed in claim 31 in which a selection rule database having a number of different selection rules stored therein for selecting the desired code to be inserted into the transmitted message is still further included in the decision repository.

33. A method for implementing targeted messaging as claimed in claim 32 in which each sender in the register of authorized senders is linked to a corresponding preferred one of the codes in the register of insertable codes.

34. A method for implementing targeted messaging as claimed in claim 33 in which each recipient in the register of authorized recipients is also linked to a corresponding preferred one of the codes in the register of insertable codes.

35. A method for implementing targeted messaging as claimed in claim 34 in which one of the codes in the register of insertable codes is specified to be a default insertable code.

36. A method for implementing targeted messaging as claimed in claim 35 in which the linked preferred code corresponding to a recipient of the message is selected as the desired code for insertion into the message when the recipient is an authorized recipient.

37. A method for implementing targeted messaging as claimed in claim 36 in which the linked preferred code corresponding to a sender of the message is selected as the desired code for insertion into the message when the recipient of the message is not an authorized recipient and the sender is an authorized sender.

38. A method for implementing targeted messaging as claimed in claim 37 in which the default insertable code is selected as the desired code for insertion into the message when the recipient of the message is not an authorized recipient and the sender is not an authorized sender.

39. A method for implementing targeted messaging as claimed in claim 38 which includes the further step of configuring the decision repository.

40. A method for implementing targeted messaging as claimed in claim 39 in which the decision repository is configured by adding and deleting a recipient from the register of authorized recipients.

41. A method for implementing targeted messaging as claimed in claim 40 in which the decision repository is configured by adding and deleting a sender from the register of authorized senders.

42. A method for implementing targeted messaging as claimed in claim 41 in which the decision repository is configured by adding and deleting a code from the register of insertable codes.

43. A method for implementing targeted messaging as claimed in claim 42 in which the decision repository is configured by linking and de-linking any one of the codes in the register of insertable codes to any one or more of the authorized recipients and authorized senders as the corresponding preferred insertable code.

44. A method for implementing targeted messaging as claimed in claim 42 in which the decision repository is configured by selecting and de-selecting the default insertable code.

45. A method for implementing targeted messaging as claimed in any one of claims 26 to 44 which includes the further step of activating the desired inserted code by the recipient to access a repository of information.

46. A method for implementing targeted messaging as claimed in claim 45 in which includes the further step of detecting activation of the insertable code to access the repository of information.

47. A system for targeted messaging, substantially as herein described with reference to and as illustrated in the accompanying drawings.

48. A method for implementing targeted messaging, substantially as herein described with reference to the accompanying drawings.
